(19) United States
(12) Patent Application Publication
(10) Pub. No.: US 2011/0082803 A1
(43) Pub. Date: Apr. 7, 2011

(54) BUSINESS FLOW RETRIEVAL SYSTEM, BUSINESS FLOW RETRIEVAL METHOD AND BUSINESS FLOW RETRIEVAL PROGRAM

(75) Inventors: Miyuki KOWA, Fujisawa (JP); Yasuhiko Uchida, Tokyo (JP); Atsushi Shimada, Yokohama (JP); Kazuyuki Ichikawa, Sagamihara (JP)

(73) Assignee: Hitachi, Ltd.

(21) Appl. No.: 12/698,697

(22) Filed: Feb. 2, 2010

(30) Foreign Application Priority Data
Oct. 5, 2009 (JP) 2009-231183

(51) Int. Cl. G06Q 10/00

(52) U.S. Cl. 705/301

(57) ABSTRACT

Upon reception of a retrieval request containing a retrieval key word from a client, a business flow registration information table is searched based on the retrieval key word to acquire a flow ID and a node ID of a business flow containing the retrieval key word. The flow ID and the node ID acquired are stored in a retrieval result table. With reference to a business flow operation history table, the node use count of the acquired node ID is divided by the flow use count of the acquired flow ID to calculate a node pass ratio. The calculated node pass ratio is stored in a node pass ratio table. With the node pass ratio as a score, the node pass ratio information is sorted in the descending order of the score. The retrieval request display data is generated in the order of sorting, and sent to the client.

### INCORPORATION BY REFERENCE

The present application claims priority from Japanese application JP2009-231183 filed on Oct. 5, 2009, the content of which is hereby incorporated by reference into this application.

### BACKGROUND OF THE INVENTION

This invention relates to a business flow retrieval system, a business flow retrieval method and a business flow retrieval program for acquiring the proper business flow desired by the user from the business flows indicating the intracompany rules and procedures.

There are various intracompany rules and procedures which can be illustrated as a business flow. By doing so, the rules and the procedures can be visually grasped easily and the efficiency of the intracompany business can be improved as a whole.

Nevertheless, the rules and the procedures may be frequently changed, and the contents of the business conducted by the user may be complicated more. In such a case, new business flows may be generated or each of the existing business flows may be divided into plural flows, resulting in a vast amount of business flows.

From this vast amount of business flows, the user is required to retrieve the desired one to conduct. As one means to solve this problem, the user extracts a business flow with a term indicating a particular business as a key word and selects the proper business flow by confirming the content of the extracted one.

A conventional technique has been disclosed in which accumulated business flows are searched based on a hierarchical structure of the business flows (for example, JP-A-2006-285313). Other conventional techniques include JP-A-2008-310566 in which a business flow is accepted and from the state of the flow, an analogous business flow is extracted to calculate the analogy, and JP-A-2006-260333 in which a retrieval table is automatically generated based on the flow designated by the user and the analogy is calculated from the action parts constituting the flow and the attribute thereof thereby to extract a flow high in analogy.

### SUMMARY OF THE INVENTION

According to the conventional techniques, a few candidates for the business flow desired by the user can be selected from a vast number of business flows by the search based on the coincidence of the key word related to the business. In the case where the key word is contained by a node in other than the main process of the business flow, however, a business flow not related to the job desired by the user may be ranked in high order of the search result. This problem is explained with reference to FIGS. 2A to 2C.

FIGS. 2A to 2C are diagrams for explaining an example of the business flow related to “address change”. Consider a case, for example, in which an employee of a company with the work force of 10,000 which recruits 200 new employees every year is transferred to another branch office and desires to follow the procedure to change his/her address registered as the employee information. Assume that the employee makes the search based on the coincidence of the key word “address change” and acquires three business flows shown in FIGS. 2A to 2C, i.e. the year-end tax adjustment procedure shown in FIG. 2A, the new employment procedure shown in FIG. 2B and the job transfer procedure shown in FIG. 2C. Every business flow shown in FIGS. 2A to 2C contains the description relating to “address change” such as “generation of written application for address change” and “submittal of address change report”.

FIG. 2A shows the business flow for the year-end tax adjustment procedure. This business flow involves all the employees, and therefore, the number of times the flow is used (hereinafter sometimes referred to as “the flow use count”) is 10,000 equal to the total number of employees. FIG. 2B shows the business flow for the new employment procedure. This business flow covers all the new employees, and therefore, is used 200 times. Further, FIG. 2C shows the business flow for the job transfer procedure. The job transfer cases are not so great in number, and therefore, the flow use number is assumed to be, for example, 100.

The employee involved desires the business flow shown in FIG. 2C describing the address change procedure required in the case of a job transfer. In the conventional technique of search with a key word, however, the scoring (evaluation) is based on the flow use count, and therefore, the business flows are ranked in the order of FIG. 2A, FIG. 2B and FIG. 2C. Thus, the business flow desired by the employee involved is not ranked in high order.

As a result, the user is required to make greater efforts to retrieve the desired business flow from the search result acquired by the search using a key word, thereby consuming a considerable time before starting the work in real terms.

According to the conventional techniques, the business flow desired by the user is extracted based on the state of a business flow or the contents of the nodes constituting the business flow. The conventional techniques, however, fail to take into consideration which process in a business flow is mainly used for the actual business, and pose the problem that is it impossible to judge whether the business flow extracted is useful or not.

This invention has been achieved to solve this problem, and the object thereof is to provide a business flow retrieval system, a business flow retrieval method and a business flow retrieval program capable of easily acquiring the business flow desired by the user.

In order to achieve this object, according to this invention, there is provided a business flow retrieval system, wherein upon acceptance of a key word for retrieval of a business, the pass ratio of the nodes of the business flow containing the retrieval key word received from a client PC is calculated using the number of times each business flow and the nodes making up the business flow are accessed, and the business flows are rearranged based on the node pass ratio thus calculated. As a result, the user can easily extract the desired proper business flow simply by inputting the retrieval key word for the desired business.

According to this invention, the user can easily acquire the business flow desired by him/her.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a general configuration of a business flow retrieval system according to a first embodiment.

FIGS. 2A to 2C are diagrams for explaining an example of the business flows related to “address change”.

FIG. 3 is a flowchart showing the process executed by a request execution/result output unit.

FIG. 4 is flowchart showing the process executed by a screen display unit.

FIG. 5 is a flowchart showing the process executed by a business flow extraction unit.

FIG. 6 is a flowchart showing the process executed by a retrieval execution/retrieval result acquisition unit.

FIG. 7 is a flowchart showing the process executed by a node pass ratio extraction unit.

FIG. 8 is a flowchart showing the process executed by a display data generation unit.

FIG. 9 is a diagram for explaining an example of a business flow registration information table.

FIG. 10 is a diagram for explaining an example of a business flow operation history table.

FIG. 11 is a diagram for explaining an example of a retrieval result table.

FIG. 12 is a diagram for explaining an example of a node pass ratio table.

FIG. 13 is a diagram for explaining an example of display on a business flow retrieval screen.

FIGS. 14A to 14C are diagrams for explaining an example of a business flow list after application of the first embodiment.

FIGS. 15A and 15B are diagrams for explaining an example of a business flow list after application of a second embodiment.

FIG. 16 is a diagram for explaining an example of display on a business flow list display screen.

FIG. 17 is a flowchart showing the process executed by a business flow operation history storage unit.

FIG. 18 is a diagram for explaining an example of a business flow operation history/execution time table according to a third embodiment.

FIG. 19 is a diagram for explaining an example of a business flow route information registration table according to a fourth embodiment.

FIGS. 20A and 20B are diagrams for explaining an example of a business flow list after application of the fourth embodiment.

FIGS. 21A and 21B are diagrams for explaining an example of a business flow list after application of a fifth embodiment.

### DETAILED DESCRIPTION OF THE INVENTION

Embodiments of the invention are explained in detail below with reference to the drawings.

### First Embodiment

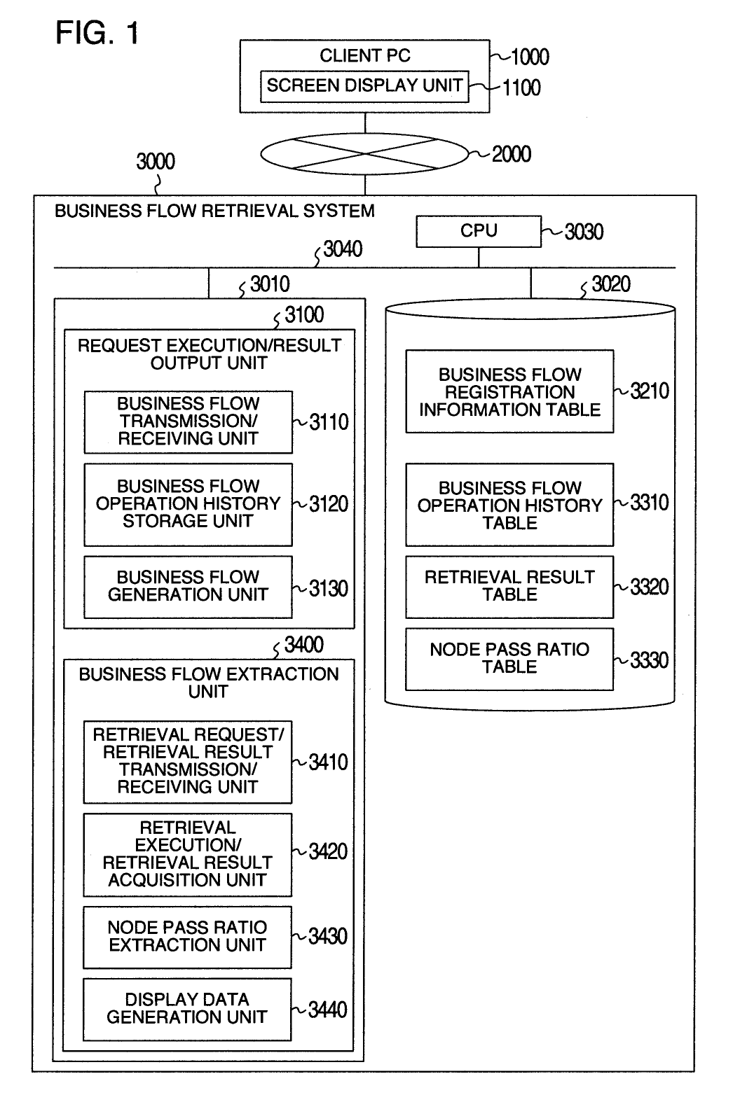

FIG. 1 is a diagram showing a general configuration of a business flow retrieval system according to a first embodiment. A business flow retrieval system 3000 is configured of a main memory 3010, a magnetic disk unit (storage unit) 3020, a CPU (central processing unit) 3030 and a system bus 3040 for connecting these units. The CPU 3030 executes various programs stored in the main memory 3010. The main memory 3010 is used to hold the data for the various processing units to execute the process of the business flow retrieval system 3000 and temporary data. The magnetic disk unit 3020 is used to store the data generated by the business flow retrieval system 3000.

The business flow retrieval system 3000 is connected with plural clients PC 1000 through a network 2000 such as LAN (local area network) or WAN (wide area network) in a way communicable with each other.

The main memory 3010 has stored therein a request execution/result output unit (request output unit) 3100. The request execution/result output unit 3100 receives a business flow display request from any one of the clients PC 1000 and sends the display data to the client PC 1000. The request execution/result output unit 3100 includes a business flow transmission/receiving unit 3110, a business flow operation history storage unit 3120 and a business flow generation unit 3130.

Also, the main memory 3010 has stored therein a program for a business flow extraction unit 3400. The business flow extraction unit 3400 receives a business flow acquisition request from any one of the clients PC 1000 and sends the business flow acquisition result to the particular client PC 1000. The business flow extraction unit 3400 includes a retrieval request/retrieval result transmission/receiving unit 3410, a retrieval execution/retrieval result acquisition unit 3420, a node pass ratio extraction unit 3430 and a display data generation unit 3440.

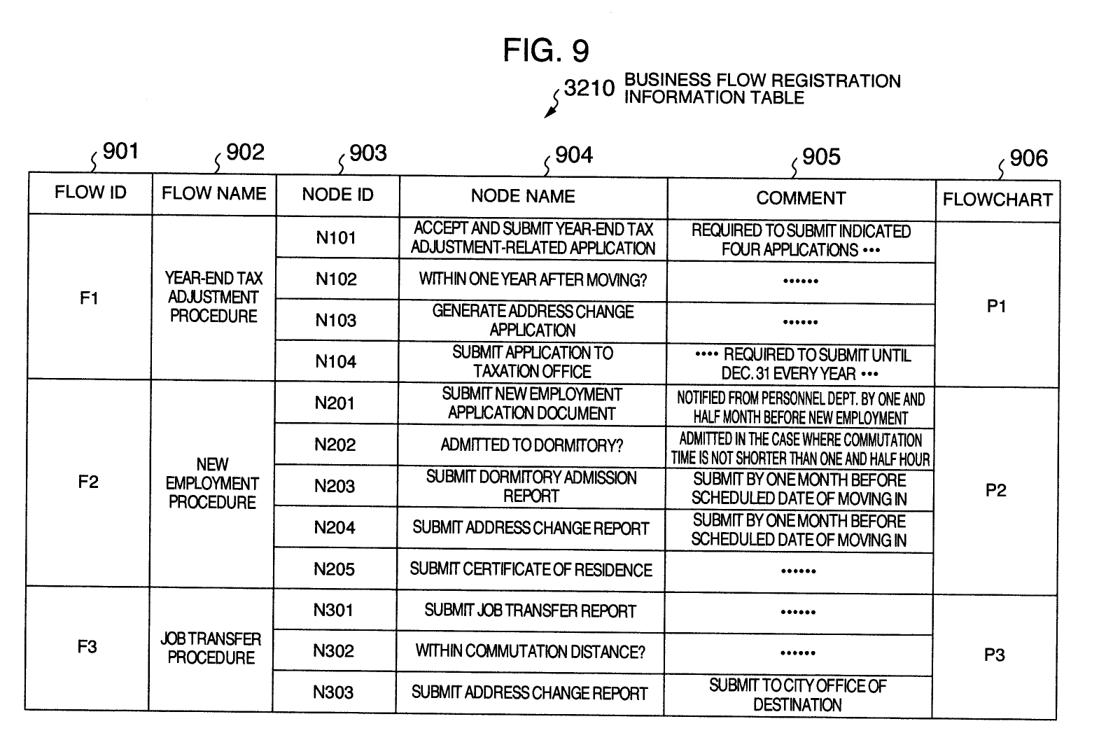

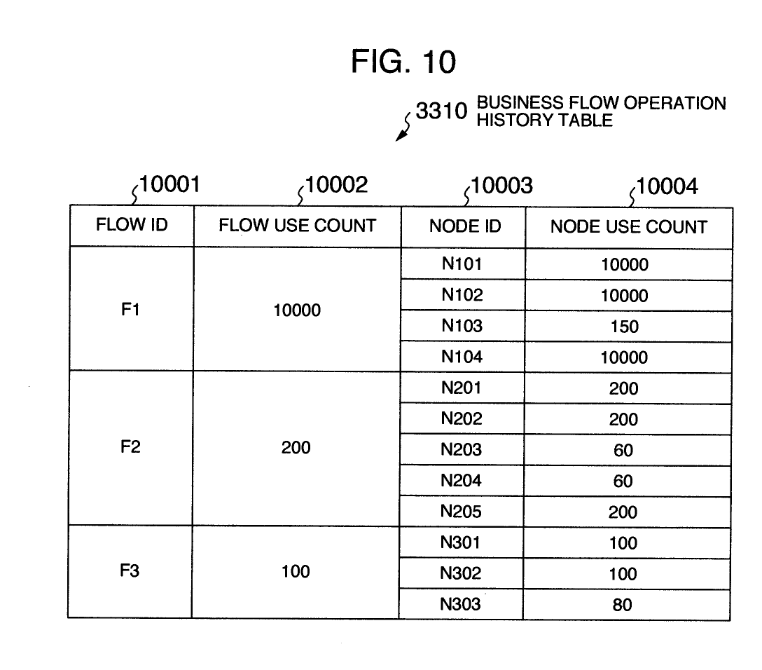

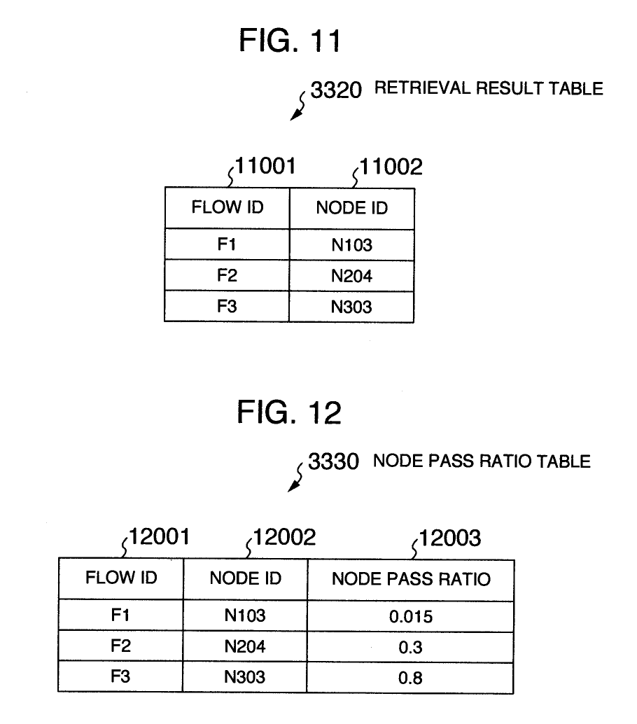

The magnetic disk unit 3020 has stored therein a business flow registration information table (business flow registration information) 3210 (FIG. 9), a business flow operation history table (business flow operation history information) 3310 (FIG. 10), a retrieval result table (retrieval result information) 3320 (FIG. 11) and a node pass ratio table 3330 (node pass ratio information) (FIG. 12).

Incidentally, the information of the business flow registration information table 3210, though stored in the magnetic disk unit 3020 in the business flow retrieval system 3000 shown in FIG. 1, may alternatively be stored in a magnetic disk of another server on the network 2000. Also, the information of the business flow registration information table 3210 (FIG. 9) is registered in advance by a system manager.

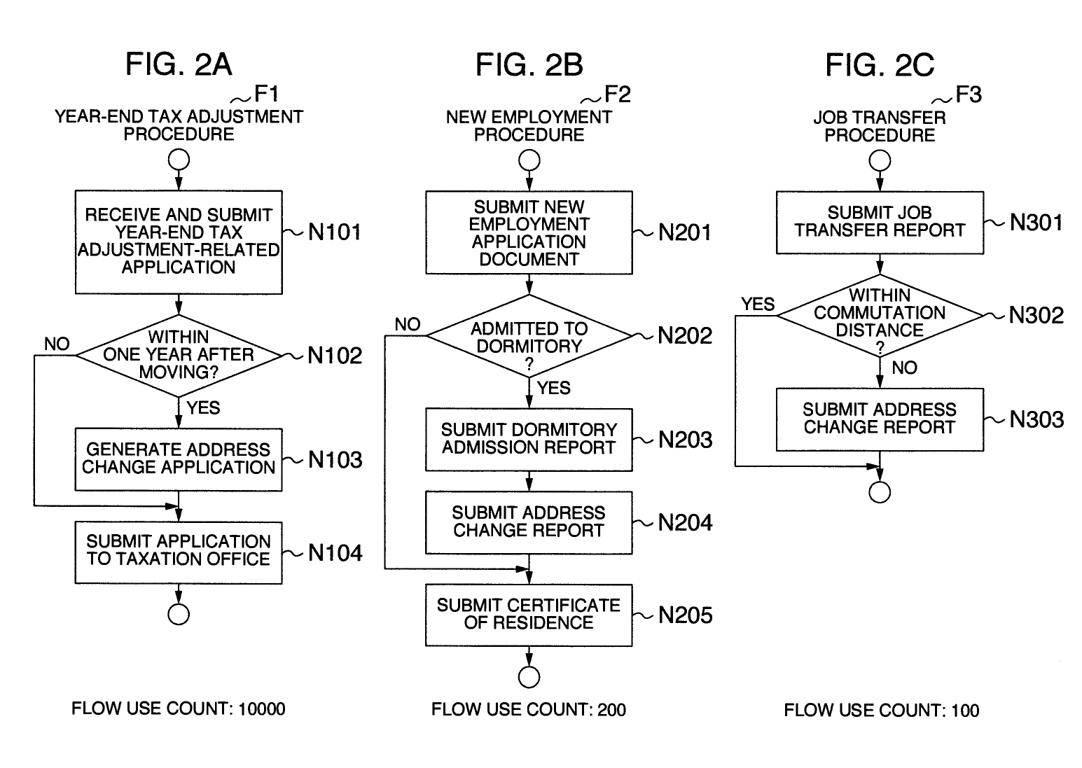

FIG. 9 is a diagram for explaining an example of the business flow registration information table. FIGS. 2A to 2C are also referred to appropriately. The business flow registration information table 3210 is configured of a flow ID 901 for identifying a business flow, a flow name 902, a node ID 903 for identifying each node making a business flow, a node name 904, a comment 905 describing the job content and the notes for carrying out the job and a flow chart 906 as an identifier indicating the state of the business flow. Incidentally, the flowchart 906 is an identifier for display on the screen display unit 1100 (FIG. 1), and actually stored in the magnetic disk unit 3020.

Specifically, the business flow having the flow ID 901 of F1 corresponding to “year-end tax adjustment procedure” shown in FIG. 2A is configured of nodes in the name of “year-end tax adjustment procedure” including “acceptance and submittal of written year-end tax adjustment-related application” (node ID 903 of N101), “within one year after moving?” (node ID 903 of N102), “generation of written address change application” (node ID 903 of N103) and “submittal of written application to taxation office” (node ID 903 of N104).

Returning to FIG. 1, the client PC 1000, though not shown, is configured of a display unit for displaying the processing situation, etc., a keyboard for giving a command on the process execution, a mouse for executing the process from a displayed screen, a CPU (central processing unit) for executing various processes, a main memory, a magnetic disk unit, a system bus and a communication unit. Incidentally, the PC is an abbreviation of the personal computer.

Although FIG. 1 shows a system configuration in which the client PC 1000 and the business flow retrieval system 3000 constituting a server are arranged separately from each other, the functions of the client PC 1000 and the business flow retrieval system 3000 may be arranged on the same server. Also, in FIG. 1, each table stored in the magnetic disk unit 3020 may alternatively be stored in the main memory 3010.

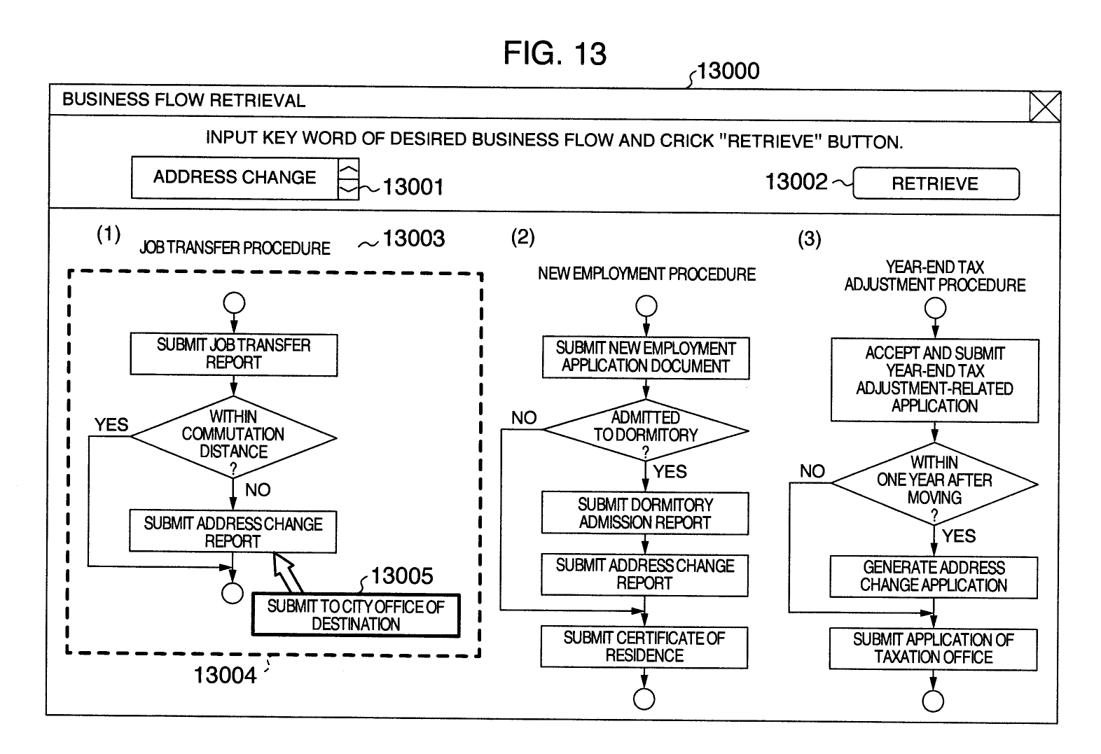

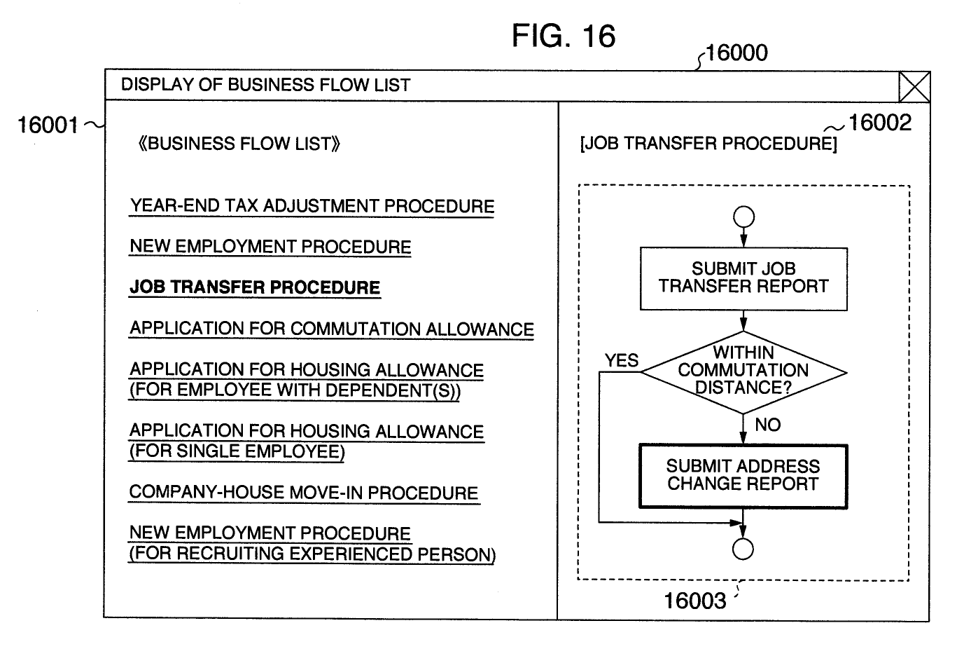

Next, the display screen on the client PC 1000 is explained. The display screen includes a business flow list screen 16000 (FIG. 16) generally used by the user and a business flow retrieval screen 13000 (FIG. 13). A department handling a multiplicity of businesses has a multiplicity of business flow list screens 16000. By retrieving the business flow name using the business flow retrieval screen 13000 shown in FIG. 13 before displaying the business flow list screen 16000 shown in FIG. 16, therefore, the user can quickly process the business.

FIG. 16 is a diagram for explaining an example of display of the business flow list display screen. The business flow list display screen has a display area 16001 for displaying the business flow names, a display area 16002 for displaying a business flow name to be displayed and a display area 16003 for displaying the flow state of the business flow to be displayed. This example represents the display area with “job transfer procedure” selected as an object to be displayed. Incidentally, the flow ID of the business flow to be displayed and the node ID are held by the client PC.

Next, the process according to this invention is explained.

### (Request Execution/Result Output Unit 3100)

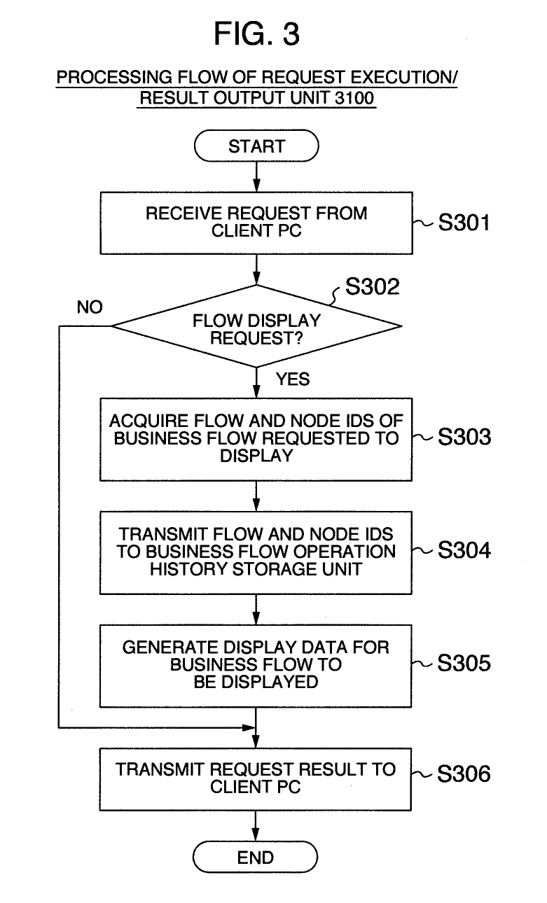

FIG. 3 is a flowchart showing the process executed by the request execution/result output unit. First, the business flow transmission/receiving unit 3110 of the request execution/result output unit 3100, upon reception of a request from the screen display unit 1100 of the client PC 1000 to display a business flow including the flow ID and the node ID of the business flow to be displayed (step S301), judges whether the received data acquisition request is a “business flow display request” or not (step S302). In the case where the data acquisition request is the “business flow display request” (YES in step S302), the flow ID corresponding to the flow name and the node ID corresponding to the node name are acquired from the business flow registration information table 3210 (step S303), and the flow ID and the node ID thus acquired are transmitted to the business flow operation history storage unit 3120 (step S304), followed by proceeding to the process of the business flow generation unit 3120 in step 305. In the case where the “business flow display request” is not involved (NO in step S302), on the other hand, the process proceeds to step S306.

In this configuration, the business flow node indicates a symbol of a process (expressed as a rectangle in FIGS. 2A to 2C) and a judgment (expressed as a rhomb in FIGS. 2A to 2C) making up a business flow. Also, the number of times used (use count) is defined as the number of times a business flow and a node are accessed by the user of the business flow retrieval system 3000.

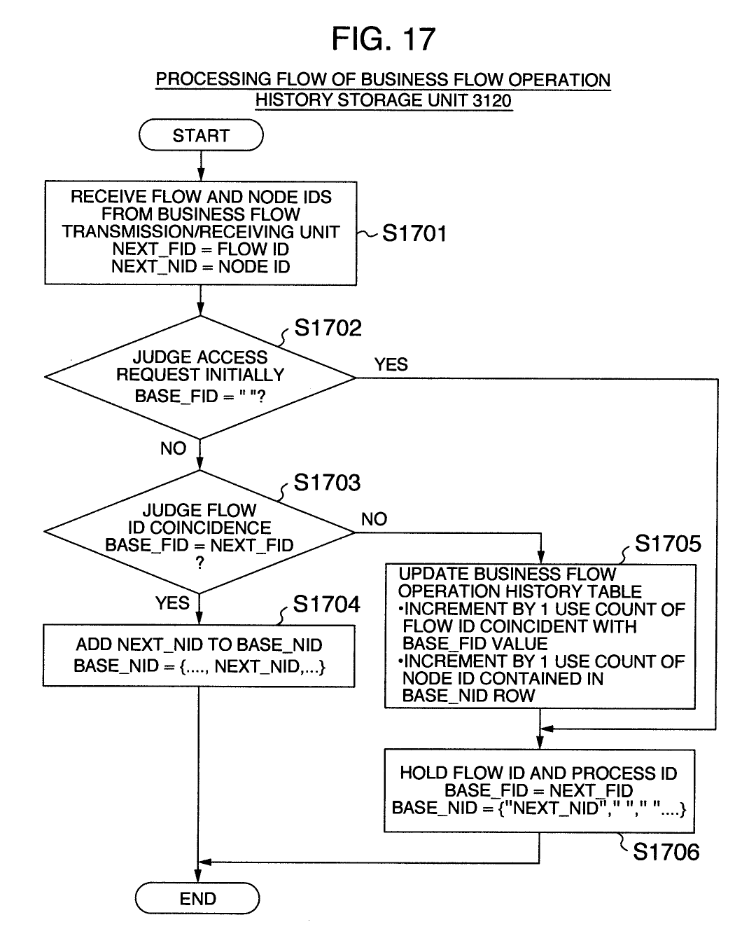

The business flow generation unit 3130 generates the data in a format adapted to be displayed on the screen display unit 1100 of the client PC 1000, from the flow ID and the node ID received (step S305), transmits the data thus generated to the client PC 1000 through the business flow transmission/receiving unit 3110 (step S306) thereby to end the process. Incidentally, the business flow operation history storage unit 3120 in step S304 is explained with reference to FIG. 17, and the business flow operation history table 3310 with reference to FIG. 10.

FIG. 17 is a flowchart showing the process executed by the business flow operation history storage unit 3120. The business flow operation history storage unit 3120 first acquires (receives) the flow ID and the node ID from the business flow transmission/receiving unit 3110, and stores them in a variable NEXT_FID for holding the flow ID and a variable NEXT_NID for holding the node ID, respectively (step S1701). Next, by judging whether the business flow refer request has been issued for the first time or not (judgment in the initial stage of the refer request) (step S1702), and if the refer request is made for the first time (YES in step S1702), the process proceeds to step S1706.

In the case where the refer request made is not the first one (NO in step S1702), on the other hand, the business flow operation history storage unit 3120 judges whether the flow ID (BASE_FID) held in step S1706 and the flow ID (NEXT_FID) acquired in step S301 coincide with each other or not (step S1703). In the case where the judgment is the coincidence (YES in step S1703), the received node ID is added to the element of the array variable BASE_NID for holding the node ID (step S1704). In the case where the judgment is the incoincidence (NO in step S1703), on the other hand, the value in the business flow operation history table 3310 is updated (step S1705). Specifically, the number of times the flow ID coincident with the value of the BASE_FID is incremented by +1, and the number of times the node ID coincident with the value of the element contained in the BASE_NID column by +1.

Next, the value held in NEXT_FID is substituted into the head element of the variable BASE_FID for holding the flow ID and the array variable BASE_NID for holding the node ID, and a null character is input in the elements of the second and subsequent items (step S1706) thereby to end the process.

FIG. 10 is a diagram for explaining an example of the business flow operation history table. The business flow operation history table 3310 is configured of a flow ID 10001 registered in the business flow registration information table 3210, a flow use count 10002 for holding the number of accesses for each flow, a node ID 10003 of the node making up the flow and a node use count (number of times the flow is used) 10004 for holding the number of accesses for each node. FIG. 10 indicates that the business flow having the flow ID of F1 is configured of node IDs of N101, N102, N103 and N104, the flow use count of the business flow having the flow ID of F1 is 10000, the node use count having the node ID of N101 is 10000, the node use count having the node ID of N102 is 10000, the node use count having the node ID of N103 is 150, and the node use count having the node ID of N104 is 10000.

### (Screen Display Unit 1100)

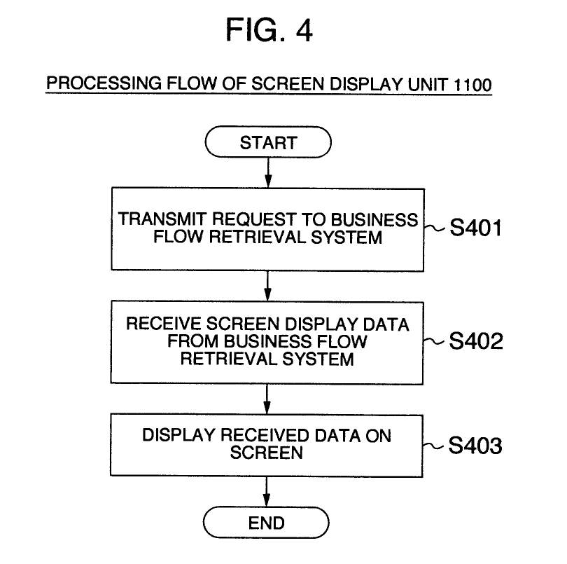

FIG. 4 is a flowchart showing the process executed by the screen display unit of the client PC. The screen display unit 1100 first transmits a request to the business flow retrieval system 3000 (step S401), and then receives the screen display data from the business flow retrieval system 3000 (step S402). The data received in step S402 is displayed on the screen (step S403).

### (Business Flow Extraction Unit 3400)

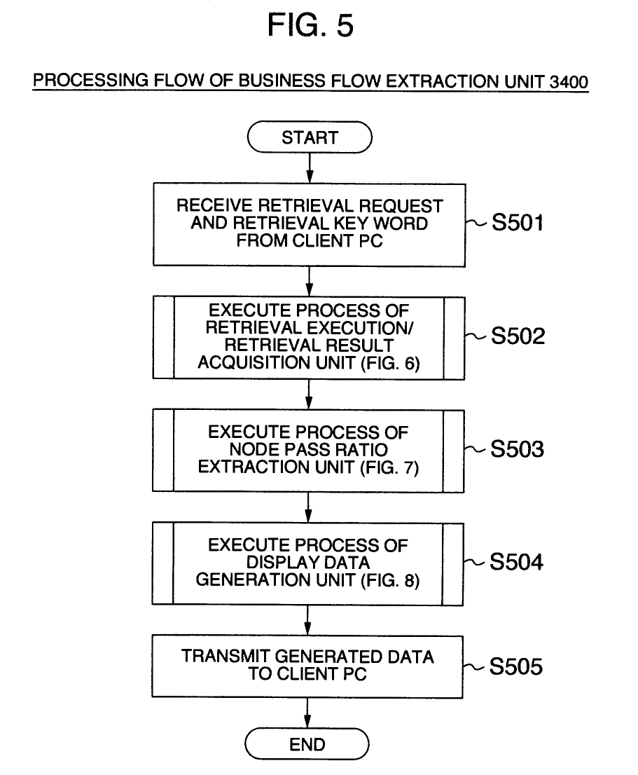

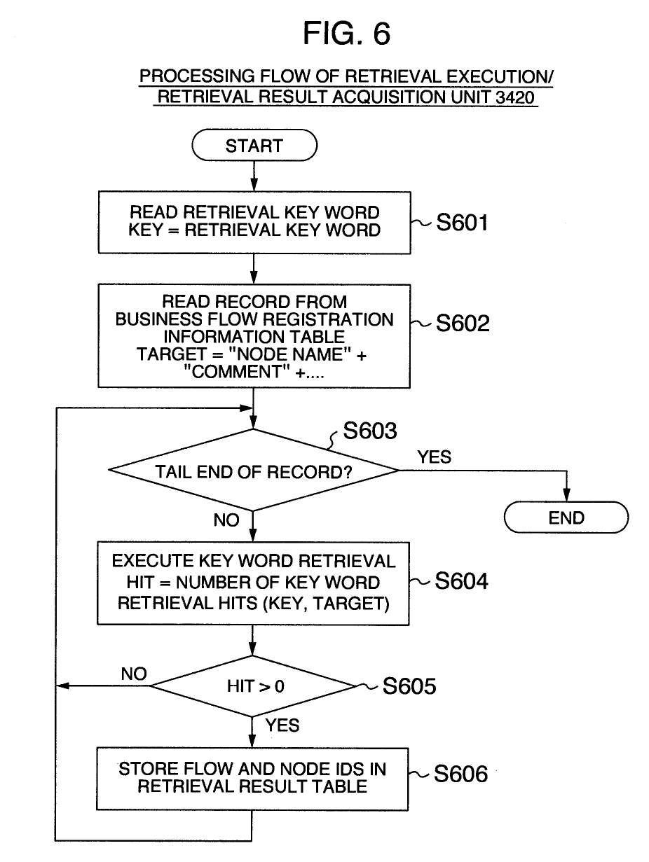

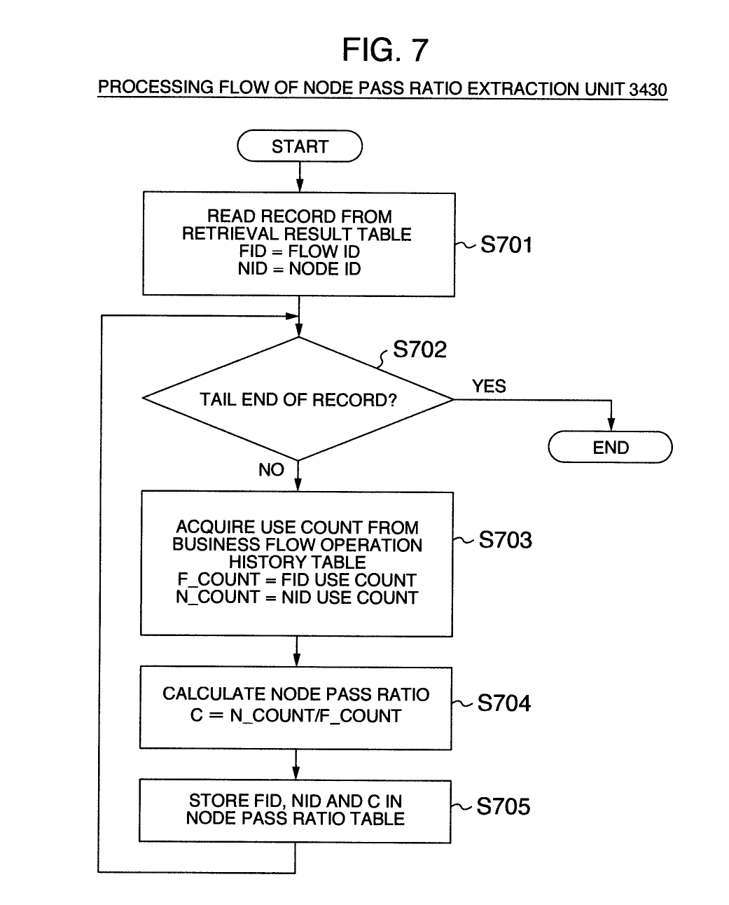

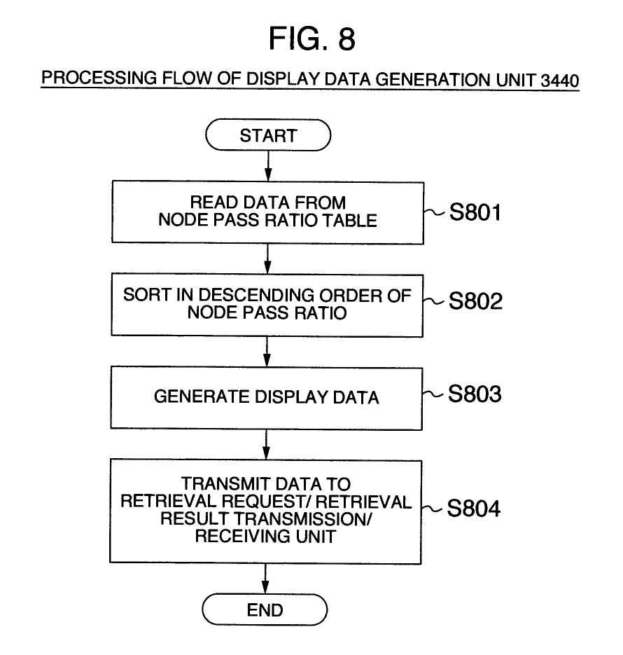

FIG. 5 is a flowchart showing the process executed by the business flow extraction unit. In the case where the retrieval request/retrieval result transmission/receiving unit 3410 receives a business flow retrieval request and a retrieval key word from the client PC 1000 (step S501), the business flow extraction unit 3400 causes the retrieval execution/retrieval result acquisition unit 3420 to execute the process thereof (step S502, FIG. 6), the node pass ratio extraction unit 3430 to execute the process thereof (step S503, FIG. 7) and the display data generation unit 3440 to executed the process therefore (step S504, FIG. 8), and transmits to the client PC 1000 the display data generated in step S504 by the retrieval request/retrieval result transmission/receiving unit 3410 (step S505). The processes executed in steps S502, S503 and S504 are explained in detail with reference to FIGS. 6 to 8.

### (Retrieval Execution/Retrieval Result Acquisition Unit 3420)

FIG. 6 is a flowchart showing the process executed by the retrieval execution/retrieval result acquisition unit 3420. As the first step in the retrieval execution/retrieval result acquisition unit 3420, the retrieval key word received from the retrieval request/retrieval result transmission/receiving unit 3410 is stored in the variable KEY for holding the retrieval key word (step S601). Next, the data corresponding to one record is read from the business flow registration information table 3210, and the flow ID thus read is stored in the variable FID for holding the flow ID, while the node ID is stored in the variable NID for holding the node ID. Also, the information containing the node name and the comment is stored in the variable TARGET for holding the object of retrieval (step S602), followed by proceeding to step S603.

Step S603 judges whether the record acquired in step S602 is that at the tail end or not. In the case where the record represents the tail end (YES in step S603), the process returns to the processor of the accessor. In the case where the record is not at the tail end (NO in step S603), on the other hand, the key word is retrieved with the variable KEY, and the number of coincidences of the retrieval key word held in the variable KEY contained in the character string of the variable TARGET is stored in the variable HIT for holding the number of coincidences (step S604), followed by proceeding to step S605.

Next, step 605 judges whether the value of the variable HIT stored in step S604 is larger than zero or not. In the case where the variable HIT is larger than zero (YES in step S605), the flow ID held in the variable FID and the node ID held in the variable NID are stored in the retrieval result table 3320 (step S606). After this storage, the process returns to step S603. In the case where step 605 judges that the value of the variable HIT is not larger than zero (NO in step S605), on the other hand, the process returns to step S603. The retrieval result table 3320 is explained with reference to FIG. 11.

FIG. 11 is a diagram for explaining an example of the retrieval result table. The retrieval result table 3320 is configured of a flow ID 11001 and a node ID 11002. Specifically, in the case where the retrieval key word is “address change”, FIG. 11 indicates that the retrieval execution/retrieval result acquisition unit 3420 searches the business flow registration information table 3210 with the retrieval key word received from the retrieval request/retrieval result transmission/receiving unit 3410, and the retrieval key word is contained in the node ID of N103 with the flow ID of F1, the node ID of N204 with the flow ID of F2, and the node ID of N303 with the flow ID of F3.

### (Node Pass Ratio Extraction Unit 3430)

FIG. 7 is a flowchart showing the process executed by the node pass ratio extraction unit. The node pass ratio extraction unit 3430 first reads one record from the retrieval result table 3320, stores the flow ID thus read in the variable FID for holding the flow ID, and stores the node ID in the variable NID for holding the node ID (step S701).

Next, step S701 judges whether the acquired record represents that at the tail end (step S702). In the case where the record represents that at the tail end (YES in step S702), the process returns to the processing unit of the accessor. In the case where the record represents other than the tail end (NO step S702), on the other hand, the numerical values of the flow use count coincident with the variable FID (number of times FID is used) and the node use count coincident with the variable NID (number of times NID is used) are acquired from the business flow operation history table 3310. The acquired flow use count is stored in the variable F_COUNT for holding the flow use count and the node use count acquired in the variable N_COUNT for holding the node use count (step S703). Then, the node pass ratio in the particular flow is calculated and the calculation result is stored in the variable C for holding the pass ratio (step S704).

In this configuration, the node pass ratio is defined as the ratio of the users who have passed a particular node among those users who have accessed the business flow. This ratio is calculated from N_COUNT/F_COUNT.

In step S705, the values of the variables FID and NID stored in step S701 and the variable C stored in step S704 are stored in the node pass ratio table S3330 (step S705), and the process returns to step S702. The node pass ratio table 3330 is explained with reference to FIG. 12.

FIG. 12 is a diagram for explaining an example of the node pass ratio table. The node pass ratio table 3330 is configured of a flow ID 12001, a node ID 12002 and a node pass ratio 12003. In this configuration, the node pass ratio is calculated by dividing the node use count by the flow use count. FIG. 12 indicates that the node with the flow ID of F1 and the node ID of N103 has the node pass ratio of 0.015, and therefore, 1.5% of all the users who have accessed the business flow with the flow ID of F1 has passed through the particular node. Incidentally, the node pass ratio is one of the scores for business flow retrieval.

### (Display Data Generation Unit 3440)

FIG. 8 is a flowchart showing the process executed by the display data generation unit. The display data generation unit 3440 first reads the data from the node pass ratio table 3330 (step S801). Then, the data are sorted (rearranged) in the descending order of the node pass ratio of the nodes contained in the record acquired in step S801 (step S802). Then, using the data rearranged in step S802, the display data to be displayed in the client PC 1000 is generated (step S803) and transmitted to the accessor, i.e. the retrieval request/retrieval result transmission/receiving unit (step S804).

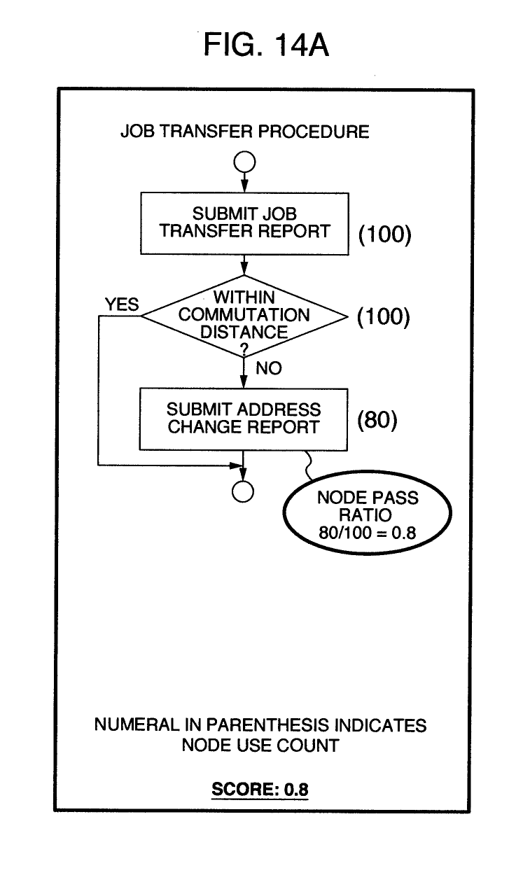

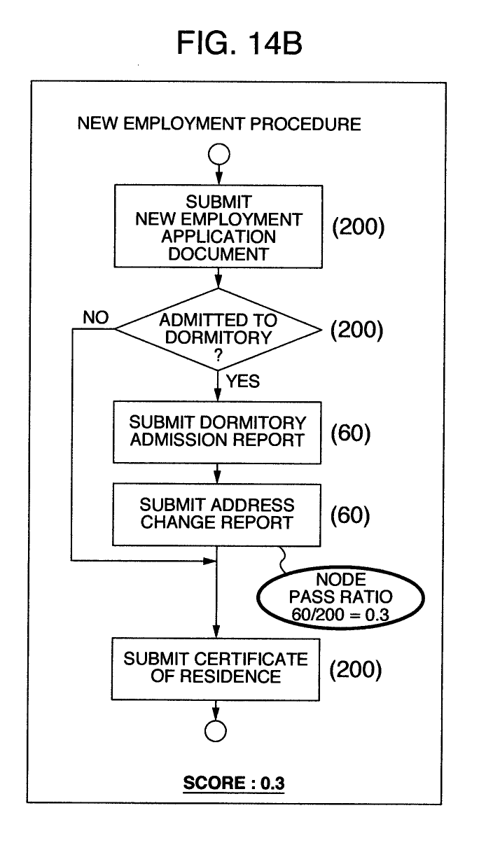

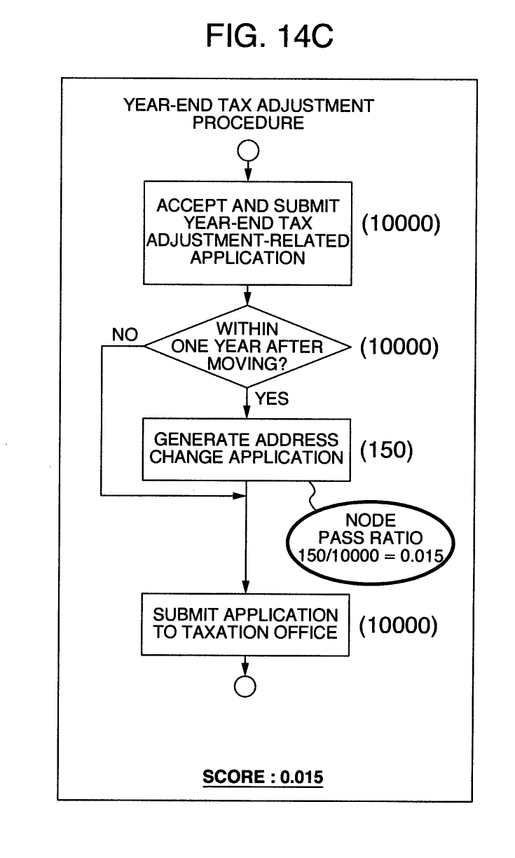

FIGS. 14A to 14C are diagrams for explaining an example of the business flow list after application of the first embodiment, and show the node pass ratio as a score for evaluation. In the case of FIG. 14A, the node pass ratio is 0.8, and therefore, the score is 0.8. In the case of FIG. 14B, on the other hand, the node pass ratio is 0.8 and the score is 0.3. Also, in the case of FIG. 14C, the node pass ratio is 0.015 and therefore, the score is 0.015.

In the prior art shown in FIGS. 2A to 2C, the business flows are ranked in the order of the number of times each flow is used by the user. Thus, the business flows “year-end tax adjustment procedure”, “new employment procedure” and “job transfer procedure” extracted are arranged in that order. According to this embodiment shown in FIG. 14, on the other hand, the business flows are arranged in the order of the score, and therefore, the extracted business flow names “job transfer procedure”, “new employment procedure” and “year-end tax adjustment procedure” are arranged in that order. Thus, the user, as the employee involved, described above with the problem of the prior art can ranks the business flows in the desired order.

FIG. 13 is a diagram for explaining an example of display on the business flow retrieval screen. The business flow retrieval screen 13000 displays a retrieval key word input area 13001, a retrieval execution command button 13002, a flow name 13003 as the result of generation of a business flow and a business flow state 13004. A node comment 13005 is displayed by the user clicking “business process” on the screen.

Specifically, assume that the user inputs “address change” in the retrieval key word input area 13001 and clicks the retrieval execution command button 13002, for example. Then, the business flows “job transfer procedure”, “new employment procedure” and “year-end tax adjustment procedure” are output in that order on the screen as the retrieval result. By doing so, the time taken by the user to retrieve the desired business flow is shortened, and the user can immediately start the job.

### Second Embodiment

According to the first embodiment, in the processing flow of the display data generation unit 3440 shown in FIG. 8, the business flows are sorted (rearranged) in descending order of node pass ratio, and the data to display the business flows in the rearranged order on the client PC 1000 are generated. In place of the node pass ratio, however, the flow use count 10002 stored in the business flow operation history table 3310 shown in FIG. 10 may be acquired, and by calculating the sum or the product of the node passage ratio and the flow use count, the business flows may be can be rearranged in the descending order of the calculated value. This method can be suitably used especially in the case where the node pass ratio is equal (same in score)

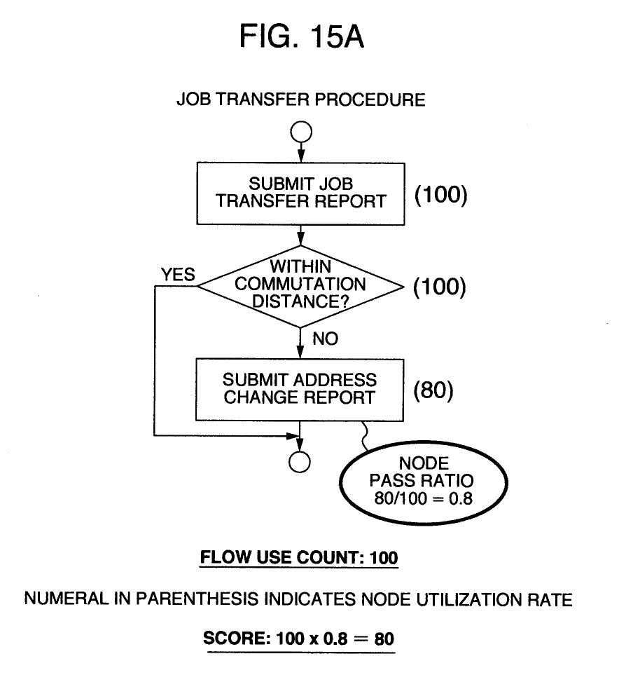

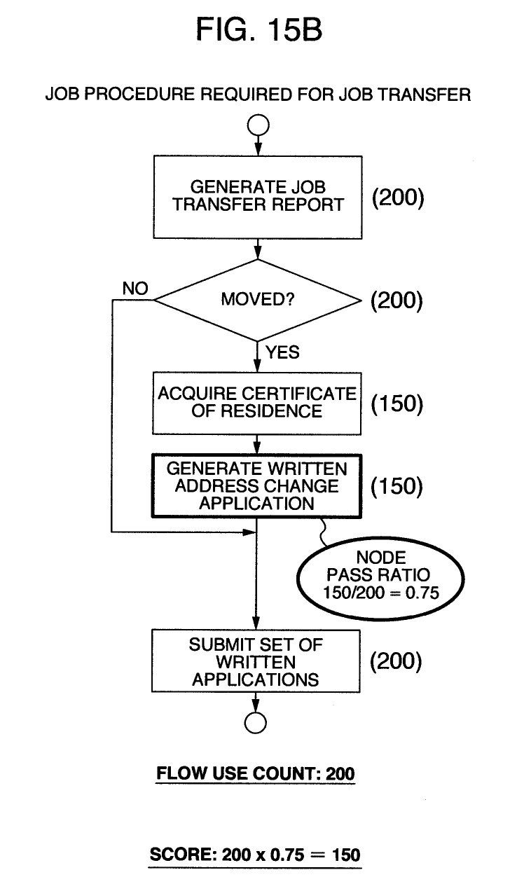

FIGS. 15A and 15B are diagrams for explaining a business flow list according to a second embodiment. In FIGS. 15A and 15B, two examples of business flows obtained by designating “address change” as a retrieval key word are shown. Incidentally, this example represents a case in which the product of the node pass ratio and the number of times a business flow (business flow use count) is calculated, and the business flows are ranked in the descending order of the calculated value. A node containing “address change” exists in both FIGS. 15A and 15B. In the case of FIG. 15A, the flow use count is 100 and the node pass ratio 0.8, so that the score (assessment value) can be calculated as 80. In the case of FIG. 15B, on the other hand, the score can be calculated as 150 in view of the fact that the flow use count is 200 and the node pass ratio 0.75. Based on the numerical values thus calculated, the business flows shown in FIGS. 15B and 15A can be ranked in that order. Incidentally, the score can be calculated in such a manner that the node pass ratio is calculated as a score in step S704 shown in FIG. 7, and this calculated score (assessment value) is added to the node pass ratio table 3330 in step S705.

According to the second embodiment, the business flows are sorted in the order of the product of the calculated node pass ratio and the flow use count constituting the number of employees involved in each business flow, i.e. the node use count, instead of in the descending order of the node pass ratio as in the first embodiment or in the case where the node pass ratio calculated in the first embodiment is the same (the same score).

### Third Embodiment

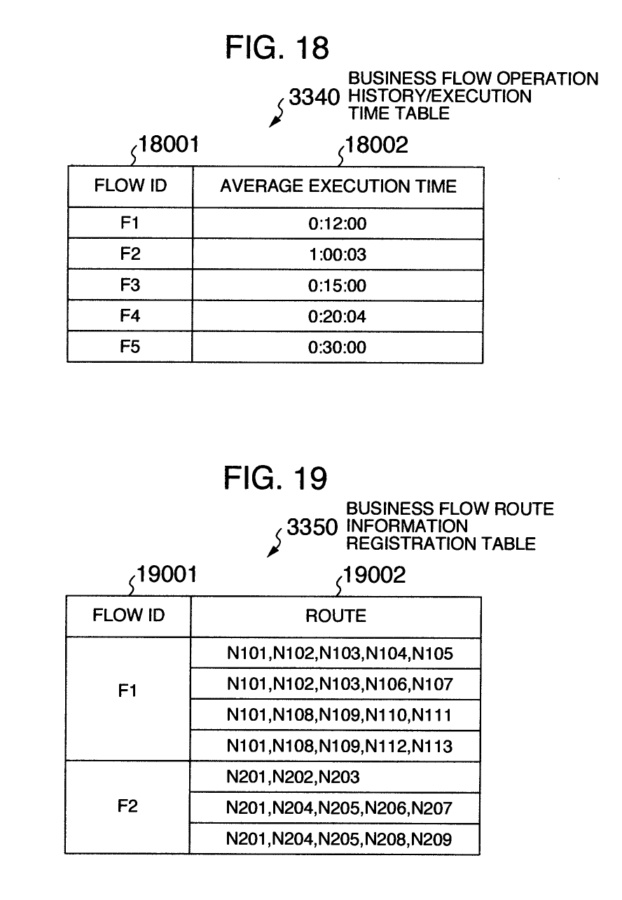

According to a third embodiment, the business flows are rearranged based on the execution time of the business flow retrieval system 3000 in place of the node pass ratio. The request execution/result output unit 3100 shown in FIG. 1 has added thereto a business flow operation history/execution time storage unit 3140 (not shown) which, upon reception of a retrieval request from the client PC 1000, acquires the flow ID of a business flow and the average value of the execution time of a business flow retrieval server required before completion of the process of the business flow (hereinafter referred to as the average processing time) on the one hand, and the magnetic disk unit 3020 has added thereto a business flow operation history/execution time table 3340 (FIG. 18) on the other hand.

FIG. 18 is a diagram for explaining an example of the business flow operation history/execution time table 3340. The flow ID and the average execution time acquired from the business flow operation history/execution time storage unit 3140 are stored in the flow ID 18001 and the average execution time 18002, respectively, of the business flow operation history/execution time table 3340. Specifically, in the case where the flow ID is F2, the process of the business flow takes one hour and three seconds (1:00:03). The display data generation unit 3440, in step S802 shown in FIG. 8, can rearrange the business flows in the descending order of the average processing time with reference to the business flow operation history/execution time table 3340. This is applicable especially in the case where the node pass ratio is the same (the score is the same).

According to the third embodiment, the average processing time of the business flow may be displayed on the business flow retrieval screen 13000 shown in FIG. 13. With reference to the average processing time thus displayed, the user can judge whether the business flow involved is to be carried out immediately or later.

Also, the registration time (not shown) is held for each business flow registered in the business flow registration information table shown in FIG. 9, and the business flows can be rearranged in the order of the latest registration time especially in the case where the node pass ratio is the same (the score is the same). Incidentally, the registration time is defined as the latest time at which the information in the business flow registration information table 3210 shown in FIG. 9 is newly registered or updated by the manager.

### Fourth Embodiment

According to a fourth embodiment, in the case where there are a plurality of nodes of a business flow each containing a retrieval key word received from the client PC 1000, the business flow is assessed using the business flow route information in place of the node pass ratio used for a single node. The magnetic disk unit 3020 shown in FIG. 1 has a business flow route information registration (business flow route information) table 3350 (FIG. 19).

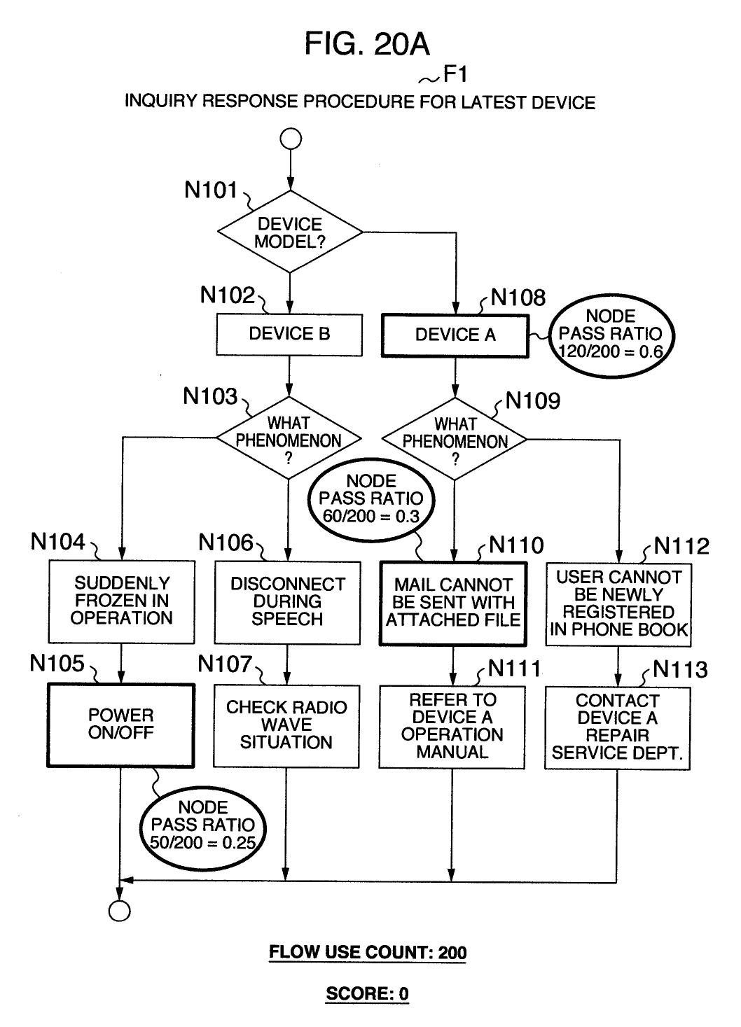

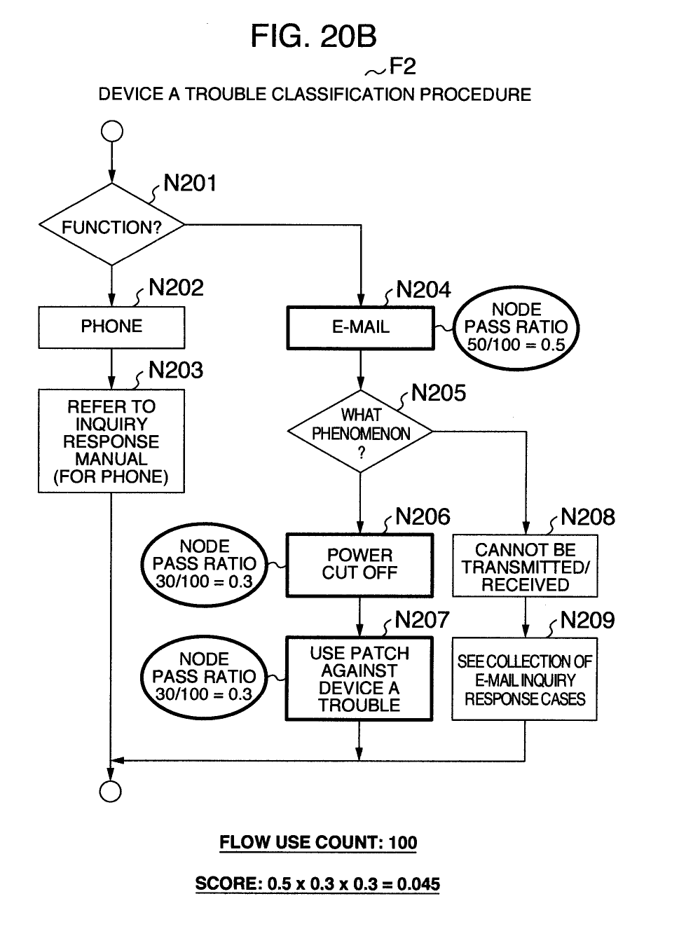

FIG. 19 is a diagram for explaining an example of the business flow route information registration table according to the fourth embodiment. In FIG. 19, the business flow route information of the business flow of FIG. 20 is shown. The business flow route information registration table 3350 is configured of a flow ID 19001 of the business flow and a route 19002 leading from the head to the tail end of the particular business flow. The route 19002 has stored therein a node train passed.

The node pass ratio extraction unit 3430 judges whether there exists a route passed through all the nodes containing the retrieval key word. In the case where such a route exists, the sum or the product of the pass ratios of the nodes containing the retrieval key word is calculated, and with the calculated value as the pass ratio of the business flow, the business flows can be rearranged in the descending order of the pass ratio. Incidentally, in the case where there exists no route, the calculation is made with the pass ratio as zero. A specific example is explained with reference to FIGS. 20A and 20B.

FIGS. 20A and 20B are diagrams for explaining an example of a business flow list according the fourth embodiment. Consider a case in which the user is an operator of a call center. The operator is required to give an accurate answer to each inquiry from customers as to the manner in which a business to be processed. For this purpose, a business flow is required to be retrieved from various business process flows.

Assume, for example, that the operator of the call center, who has received an inquiry to the effect that “the power turns off in the case where mail is sent by the device A used”, has acquired two business flows shown in FIGS. 20A and 20B with “device A”, “mail” and “power” as key words. Both FIGS. 20A and 20B have nodes including the retrieval key words “device A”, “mail” and “power”. The business flow of FIG. 20A, however, has no route passing through all the nodes having these key words. Therefore, the pass ratio of FIG. 20A is zero. In FIG. 20B, on the other hand, there exists a route passing through all the nodes having these key words, and therefore, the pass ratio in FIG. 20B is calculated as the sum or the product of the pass ratios of the respective nodes. In this example, the result of calculating the product of the pass ratios of the nodes is shown, and the score of FIG. 20B can be calculated as 0.45. As described above, according to the fourth embodiment, FIGS. 20B and 20A can be ranked in that order.

### Fifth Embodiment

According to a fifth embodiment, each business flow is weighted by the component parts (node name, comment) thereof containing the retrieval key word received from the client PC 1000 instead of scoring by the node pass ratio. By this weighting process, the node pass ratios are added so that the business flows are rearranged in the descending order of the node pass ratio after addition.

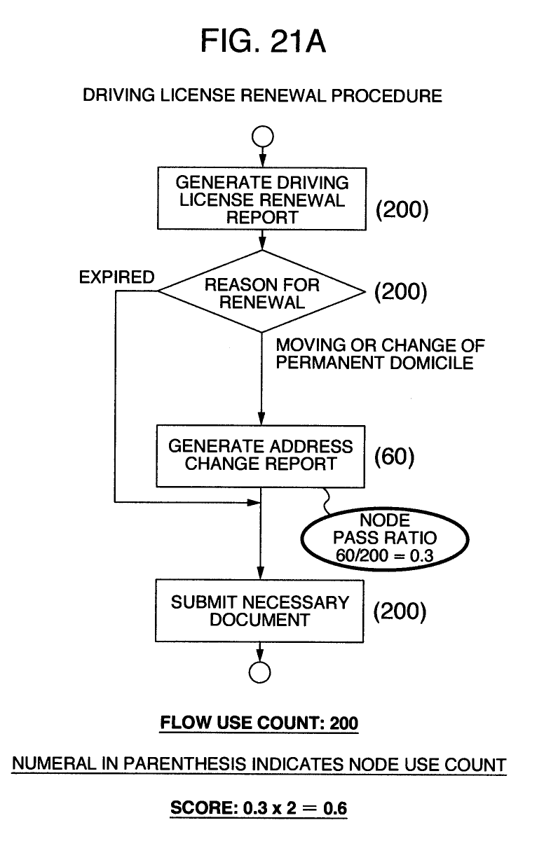

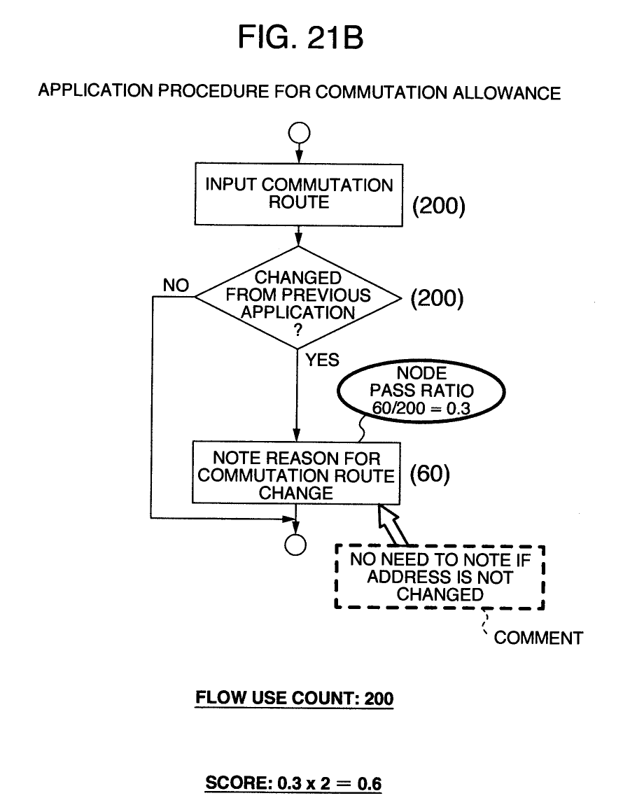

FIGS. 21A and 21B are diagrams for explaining an example of a business flow list according to the fifth embodiment. For example, assume that “address change” is set as a key word and the flow name in the business flow is weighted twice the comment with the result that the business flow names shown in FIGS. 21A and 21B are obtained. Both FIGS. 21A and 21B contain “address change”. The key word “address change” is contained in a node name in FIG. 21A, while it is contained in a comment in FIG. 21B. Therefore, the pass ratio of the business flow shown in FIG. 21A is calculated as 0.6 in such a manner that the pass ratio 0.3 of the node containing “address change” is multiplied by a predetermined value (for example, 2), while the node pass ratio of FIG. 21B remains 0.3. In this way, the business flows of FIGS. 21A and 21B are ranked in that order. This is applicable suitably especially in the case where the node pass ratio is the same (same score).

The business flow retrieval system 3000 according to this embodiment includes a request execution/result output unit (request output unit) 3100 and a business flow extraction unit 3400. The request output unit, upon reception of a request containing a flow ID and a node ID from a client (for example, the client PC 1000), updates the flow use count corresponding to the flow ID received and the node use count of each node corresponding to the node ID received as the business flow operation history table 3310 (business flow registration information), and by generating the display data for the request based on the flow ID and the node ID with reference to the business flow registration information table 3210 (business flow registration information), sends the request display data to the client.

The business flow extraction unit 3400, upon reception of a retrieval request containing a retrieval key word from a client, searches the business flow registration information table 3210 based on the retrieval key word, and acquires the flow ID and the node ID of the business flow including the retrieval key word. The acquired flow and node IDs are stored in the retrieval result table 3320, and with reference to the business flow operation history table 3310, the node use count of the acquired node ID is divided by the flow use count of the acquired flow ID thereby to calculate the node pass ratio. The node pass ratio thus calculated is related to the acquired flow and node IDs and stored in the node pass ratio table 3330. Then, the node pass ratio information sorted in the descending order of the node pass ratio as a score, and the retrieval request display data is generated in the order of sorting and sent to the client.

Although the embodiments are explained above using an example of the configuration of a client/server system including the client PC 1000 and the business flow retrieval system 3000 connected communicably to each other through the network 2000. Nevertheless, the invention is not limited to this configuration, but applicable also to a computer such as a PC or a work station in which the business flow retrieval process and the screen display process are integrated with each other.

It should be further understood by those skilled in the art that although the foregoing description has been made on embodiments of the invention, the invention is not limited thereto and various changes and modifications may be made without departing from the spirit of the invention and the scope of the appended claims.

1. A business flow retrieval system for managing the history information of a business flow retrieval request and retrieving and extracting the business flow requested to retrieve from a plurality of business flows in response to the business flow retrieval request, comprising:
a storage unit for storing the business flow registration information including a flow ID for identifying the business flow, a flow name, a node ID for identifying a node making up the business flow, a node name and a comment of the node;
a request output unit which, upon reception of a request containing the flow ID and the node ID, updates the flow use count corresponding to the flow ID received and the node use count of each node corresponding to the node ID received as business flow operation history information, generates the data for displaying the request based on the received flow and node IDs with reference to the business flow registration information, and outputs the display data for the request; and
a business flow extraction unit which, upon reception of a retrieval request containing a retrieval key word, searches the business flow registration information based on the retrieval key word, acquires the flow and node IDs of the business flow containing the retrieval key word in at least one of the flow name, the node name and a comment, calculates the node pass ratio by dividing the node use count of the acquired node ID by the flow use count of the acquired flow ID with reference to the business flow operation history information, stores the calculated node pass ratio in the node pass ratio information in the form related to the flow ID and the node ID acquired, sorts the node pass ratio information in the descending order of the node pass ratio as a score, generates the retrieval request display data in the order of sorting, and outputs the retrieval request display data.

2. The business flow retrieval system according to claim 1,
wherein in the case where the score is the same, the business flow extraction unit generates the retrieval request display data in the order of the node use count of the acquired node ID.

3. The business flow retrieval system according to claim 1,
wherein in the case where the score is the same, the business flow extraction unit generates the retrieval request display data in the order of the flow use count of the acquired flow ID.

4. The business flow retrieval system according to claim 1,
wherein in the case where the score is the same, the business flow extraction unit generates the retrieval request display data is generated in the order of the processing time of the business flow operation.

5. The business flow retrieval system according to claim 1,
wherein in the case where the score is the same, the business flow extraction unit generates the retrieval request display data in the order of the business flow registration time.

6. The business flow retrieval system according to claim 1,
wherein the storage unit has registered therein, as the business flow route information, the relation between the flow ID and the node ID of at least one node making up the route of the flow ID processing steps, and
wherein in the case where a business flow of one flow ID has a plurality of node IDs of the business flow containing the retrieval key word, the business flow extraction unit uses the sum or the product of at least one node pass ratio corresponding to one route as the node pass ratio score of the business flow with reference to the business flow route information.

7. The business flow retrieval system according to claim 1,
wherein the business flow extraction unit weights selected one of the node name and the comment, and
wherein the business flow extraction unit adds the node pass ratio by weighting in calculating the node pass ratio.

8. In a system including a storage unit for storing the business flow registration information containing a flow ID for identifying a business flow, a flow name, a node ID for identifying a node making up the business flow, a node name and a comment of the node, a request output unit and a business flow extraction unit thereby to manage the history information of the request for the business flow,
a business flow retrieval method for retrieving and extracting the business flow of the retrieval request from a plurality of business flows,
wherein the request output unit, upon reception of a request containing the flow ID and the node ID, updates the flow use count corresponding to the received flow ID and the node use count of each node corresponding to the received node ID as the business flow operation history information, generates the display data of the request based on the received flow and node IDs with reference to the business flow registration information, and outputs the display data for the request, and
wherein the business flow extraction unit, upon reception of a retrieval request containing a retrieval key word, searches the business flow registration information based on the retrieval key word, acquires the flow ID and the node ID of the business flow with the retrieval key word contained in any one of the flow name, the node name and the comment, calculates a node pass ratio by dividing the node use count of the acquired node ID by the flow use count of the acquired flow ID with reference to the business flow operation history information, stores the calculated node pass ratio in the node pass ratio information in the form related to the flow ID and the node ID acquired, sorts the node pass ratio information in the descending order of the node pass ratio as a score, generates the display data of the retrieval request in the order of sorting, and outputs the retrieval request display data.

9. The business flow retrieval method according to claim 8,
wherein in the case where the score is the same, the business flow extraction unit generates the retrieval request display data in the order of the node use count of the acquired node ID.

10. The business flow retrieval method according to claim 8,
wherein in the case where the score is the same, the business flow extraction unit generates the retrieval request display data in the order of the flow use count of the acquired flow ID.

11. The business flow retrieval method according to claim 8,
wherein in the case where the score is the same, the business flow extraction unit generates the retrieval request display data in the order of the processing time of the business flow operation.

12. The business flow retrieval method according to claim 8,
wherein in the case where the score is the same, the business flow extraction unit displays the retrieval request display data in the order of the registration time of the business flow.

13. The business flow retrieval method according to claim 8,
wherein the storage unit of the system has registered therein, as the business flow route information, the relation between the flow ID and at least one node ID making up the route of the processing steps of the flow ID, and
wherein in the case where a plurality of the node IDs of a business flow containing the retrieval key word exist in the business flow of one flow ID, the business flow extraction unit uses the sum or the product of at least one node pass ratio corresponding to one route as the score of the node pass ratio of the business flow with reference to the business flow route information.

14. The business flow retrieval method according to claim 8,
wherein the business flow extraction unit has selected one of the node name and the comment weighted, and
wherein the node pass ratio is calculated by addition thereof by weighting.

15. A storage medium for storing a business flow retrieval program according to which a computer, for managing the history information of a business flow request and retrieving and extracting the business flow of the retrieval request from a plurality of business flows in response to an input of the business flow retrieval request, performs:
a function to store the business flow registration information containing a flow ID for identifying the business flow, a flow name, a node ID for identifying the node making up the business flow, a node name and a comment on the node;
a function which, upon reception of a request containing the flow ID and the node ID, updates a flow use count corresponding to the received flow ID and a node use count of each node corresponding to the received node ID as the business flow operation history information, generates the display data for the request based on the received flow and node IDs with reference to the business flow registration information, and outputs the display data for the request; and
a function which, upon reception of a retrieval request containing a retrieval key word, searches the business flow registration information based on the retrieval key word, acquires the flow ID and the node ID of the business flow containing with the retrieval key word contained in selected one of the flow name, the node name and the comment, calculates the node pass ratio by dividing the node use count of the acquired node ID by the flow use count of the acquired flow ID with reference to the business flow operation history information, stores the calculated node pass ratio in the node pass ratio information in the form related to the flow ID and the node ID acquired, sorts the node pass ratio information in the descending order of the node pass ratio as a score, generates the retrieval request display data in the order of sorting, and outputs the retrieval request display data.
